(19) United States
(12) Patent Application Publication
(10) Pub. No.: US 2007/0179631 A1
(43) Pub. Date: Aug. 2, 2007

(54) System and method of communication by serial communication bus

(75) Inventors: Frederic Autran, Paris (FR); Fabrice Moreau, Creteil (FR)

Correspondence Address: Valeo Climate Control Corp.;Intellectual Property Dept., 4100 North Atlantic Boulevard, Auburn Hills, MI, 48326, US

(73) Assignee: Valeo Systems Thermiques S.A.S., Le Mesnil St Denis (FR)

(21) Appl. No.: 11/655,494

(22) Filed: Jan. 19, 2007

(30) Foreign Application Priority Data
Jan. 27, 2006 (FR) 06 00740

(51) Int. Cl. G05B 15/00

(52) U.S. Cl. 700/1

(57) ABSTRACT

This invention concerns a communication system (100) between at least one device control unit (10) connected to a device (10) to be controlled and at least one human-machine interface (HMI) through a series communication bus (4). This communication system (100) further includes a central processing unit (2) comprising means for:

receiving at least first status information (D32, D3′2) transmitted by human-machine interface (3, 3′) and at least second status information (D12) transmitted by device control unit (1);

processing first status information data (D32, D3′2) and second status information (D12) for generating at least third (D23, D23′) and fourth (D21) status information available for human-machine interface (3, 3′) and device control unit (1);

broadcasting third status information (D23, D23′) to human-machine interface (3, 3′); and

broadcasting fourth status information (D21) to at least one device control unit (1).

### BACKGROUND OF THE INVENTION

The present invention relates to the general field of systems of communication by serial bus.

The invention aims more specifically at a system and a method of communication between a plurality of man-machine interfaces (MMIs) and a control module, connected by a serial communication bus, in particular in the automobile field.

Serial communication buses are commonly used for communications between the various electronic elements present in a vehicle. These electronic elements are, for example, sensors, indicators and actuators, duly networked via such serial buses.

In automotive applications, the sensors and actuators relate, for example, to the air conditioning system, the doors (opening/closing/locking), the seat belts, the seats, temperature measurements, manual controls, windscreen wipers, roof opening releases.

In the current state of the art, a serial communication bus allows communication between equipment control modules and man-machine interfaces (MMIs) contained in control panels. The logical processing operations linked to the MMIs consisting in generating states to be displayed by the MMIs are performed in each control module.

This distributed breakdown of the logical processing operations linked to the MMIs complicates the architecture of the system and can add a maintenance overhead.

Furthermore, modifying any one of the control panels will entail modifications on each of the control modules.

### SUBJECT OF THE INVENTION

The main aim of the present invention is therefore to overcome these drawbacks. It proposes a novel system architecture enabling the logical processing associated with the MMIs to be centralized by providing, in a system of communication between at least one equipment control module linked to an equipment item and at least one man-machine interface by means of a serial communication bus, a central computer comprising means suitable for:

receiving at least first status data items transmitted via the at least one man-machine interface and at least second status data items transmitted by the at least one equipment control module;

processing at least the first and second status data items so as to produce at least third and fourth status data items respectively intended for the at least one man-machine interface and for said at least one equipment control module;

broadcasting at least the third status data items to the at least one man-machine interface; and

broadcasting at least the fourth status data items to said at least one equipment control module.

Thus, the central computer makes it possible to separate the processing of the data items originating from the MMIs and from the equipment control modules from the conventional data processing operations performed by the control modules associated with the equipment items.

Advantageously, centralizing the processing of the data items transmitted by the MMIs on the central computer according to the invention avoids any modification on the equipment control modules when adapting the control panels or modifying the MMIs.

The data items produced by the central computer are then broadcast to the man-machine interfaces and to the control modules, according to a point-to-multipoint-type transmission. Unlike the conventional system architectures, in which dialogs are conducted point-to-point between the equipment control modules and the various MMIs, the data broadcasting according to the invention produces a point-to-multipoint-type transmission, so making it possible to simplify the setting up of communications. The data items are collected by the central computer from the MMIs and control modules by a multipoint-to-point-type transmission.

According to one characteristic of the invention, the central computer is placed in a control panel comprising at least one man-machine interface.

Advantageously, the central computer is placed in any one of the control panels linked to the communication bus, each of these control panels already comprising at least one MMI.

According to another characteristic of the invention, the central computer comprises a storage means with which to store configuration information.

Thus, the central computer uses configuration information that it stores using a storage means. Such information can be used by the computer for processing the data items received by the MMIs or by the equipment control module.

According to another characteristic of the invention, the serial communication bus is an LIN (Local Interconnect Network) type bus.

The LIN (Local Interconnect Network) type serial communication buses offer the following advantages.

Firstly, the LIN technology makes it possible to guarantee the queuing time in the signal transmission. This type of bus makes it possible to achieve relatively high transmission bit rates, typically limited to 20 kbit/s for reasons associated with electromagnetic interference.

Next, the stations linked to the LIN bus according to the LIN communication protocol require no synchronization device such as a crystal-based local oscillator or a ceramic resonator. This makes it possible to reduce the material cost of implementing these stations significantly. Furthermore, the cost of producing the LIN bus itself is low, given that it is a single-wire bus.

According to another characteristic of the invention, the man-machine interfaces are of slave type and the central computer is of master type.

In a master/slave-type architecture comprising a master module and a plurality of slave modules, the master module coordinates and controls communication between the various slave modules that in particular carry out the actions ordered by the master module.

Advantageously, this type of architecture requires no arbitration means between the various man-machine interfaces for transmission and reception over the common serial communication bus.

According to another characteristic of the invention, the serial communication bus is a CAN (Controller Area Network) type bus.

The CAN-type serial communication bus is a standard communication bus in the automobile field.

The CAN bus can be set up in a multi-master architecture, in which any master equipment item can initiate the dialog. Furthermore, the CAN bus makes it possible to achieve high transmission speeds (from 125 kbit/s to 1 Mbit/s depending on the standard used). Finally, one and the same CAN bus can be used to connect a large number of equipment items (32 to 100).

Another subject of the invention is a method of communication between a central computer, at least one equipment control module connected to an equipment item, and at least one man-machine interface, the central computer performing the following steps:

reception of at least first status data items transmitted via the at least one man-machine interface and at least second status data items transmitted by the at least one equipment control module;

processing of at least the first status data items and at least the second status data items, so as to generate at least third status data items and fourth status data items respectively intended for the at least one man-machine interface and said at least one equipment control module;

broadcasting of at least the third status data items to the at least one man-machine interface; and

broadcasting of at least the fourth status data items to said at least one equipment control module.

The advantages and particular embodiments of this method are the same as those associated with the client device according to the invention, described above.

According to one characteristic of the invention, the third status data items and the fourth status data items are broadcast respectively in at least one first frame and at least one second frame.

Several information frames are required to send a data packet of a size greater than 8 bytes, given that the capacity of each information frame transmitted is limited to 8 bytes, when using a CAN or LIN bus.

According to another characteristic of the invention, the third status data items and the fourth status data items respectively intended for the at least one man-machine interface and for said at least one equipment control module are broadcast in one and the same frame.

Advantageously, this makes it possible to minimize the number of frames transmitted over the serial communication bus and so optimize the data traffic carried on the serial communication bus.

According to another characteristic of the invention, the central computer broadcasts at least one generic data frame to the at least one man-machine interface during the processing step.

Thus, the central computer can communicate an information item or a status to be displayed on the MMIs without having to wait for the end of the data processing step. This characteristic makes it possible, for example, to inform the MMIs that the central computer is processing data.

According to another characteristic of the invention, the central computer processes the data items transmitted via the at least one man-machine interface according to a priority management algorithm.

Advantageously, this priority management algorithm makes it possible to resolve any conflicts between the information transmitted by a first MMI and that transmitted by a second MMI.

According to another characteristic of the invention, the steps of the method are performed periodically.

A periodic sequencing of the steps carried out by the central computer according to the invention makes it possible to guarantee the response times of the system and so improve its performance levels.

In a preferred embodiment, the various steps of the communication method are determined by instructions of a computer program.

Consequently, the invention is also aimed at a computer program stored on an information medium and the medium itself.

This program comprises code instructions suitable for implementing the steps of the communication method as described above, and executed on the communication system according to the invention as described above.

### BRIEF DESCRIPTION OF THE DRAWINGS

Other characteristics and advantages of the present invention will become apparent from reading the description given below, with reference to the drawings which illustrate an exemplary embodiment thereof, without any limiting character, and in which:

FIG. 1 represents a system of communication by serial communication bus between a control module and two MMIs according to the invention;

FIG. 2 illustrates the method of communication between the entities of FIG. 1 according to the invention; and

FIG. 3, according to the current state of the art, represents a system of communication between two control modules and three MMIs, via a serial communication bus.

### DETAILED DESCRIPTION OF AN EMBODIMENT

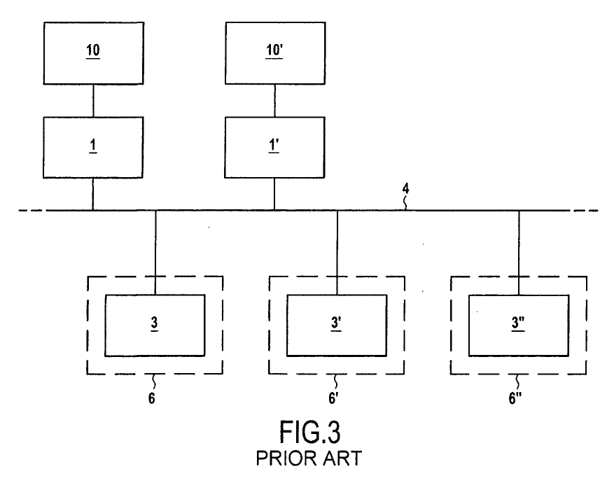

FIG. 3 describes, according to the current state of the art, a system of communication between two control modules 1, 1′ respectively linked to two equipment items 10 and 10′ and three man-machine interfaces (MMIs) 3, 3′, 3″, respectively contained in three control panels 6, 6′, 6″. An LIN (Local Interconnect Network) type serial communication bus 4 links the control modules 1, 1′ to the MMIs 3, 3′, 3″.

In this type of conventional architecture, the processing operations linked to the logic of the MMIs 3, 3′, 3″ are carried out in the control modules 1, 1′. These processing operations are performed by computers contained in the control modules 1, 1′ and suited to the MMIs 3, 3′, 3″, based on data supplied by these MMIs 3, 3′, 3″.

The processing operations linked to the logic of the MMIs 3, 3′, 3″ consist in generating states to be displayed on the MMIs 3, 3′, 3″, such as, for example, messages to be displayed on signaling screens, lamps to be switched on or switched off, or even data to be taken into account in a computation algorithm linked to a control module 1, 1′ of an equipment item 10, 10′.

In practice, modifying any one of the control panels 6, 6′, 6″, such as, for example, replacing a rotary distribution control button by several “push” type buttons may lead to changes on the control modules 1, 1′.

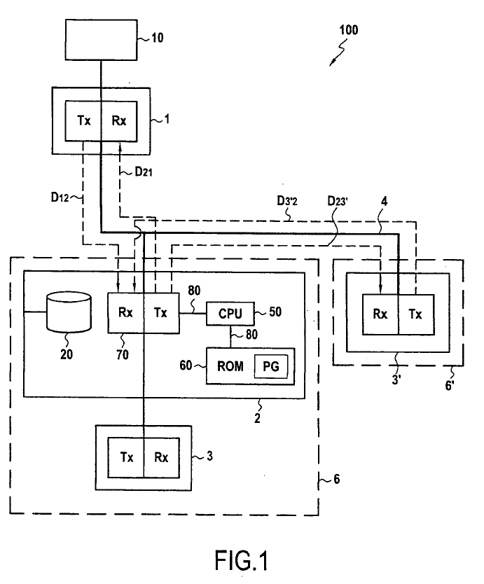

FIG. 1 illustrates a communication system according to the invention, as an example, between a control module 1 linked to an HVAC air conditioning appliance 10 and two MMIs 3, 3′. A first control panel 6 comprises a first MMI 3 and a central computer 2. A second control panel 6′ comprises a second MMI 3′. The two control panels 6, 6′ are linked to the control module 1 by one and the same LIN-type serial communication bus 4, for example.

Thus, the MMI 3′ communicates directly with the central computer 2, via the serial communication bus 4. Given that the MMI 3 and the central computer 2 are, in this example, hosted by the same control panel 6, the MMI 3 communicates directly internally with the central computer 2, without involving the serial communication bus 4. In this example, the central computer 2 therefore communicates directly with the MMI 3′ and the control module 1 via the serial communication bus 4, and communicates directly internally with the MMI 3.

According to the invention, the system provides for a central computer 2 linked to the first MMI 3 via an internal communication bus that is not referenced, in the control panel 6. This central computer 2 also comprises storage means 20 for storing configuration information. This configuration information can be used, for example, to attach a priority level to the information supplied by the MMIs 3, 3′ and the control module 1. In the example described here, the central computer 2 comprises a central processing unit (CPU) 50, a memory (ROM) 60, a communication interface 70 and a bus system 80 for interlinking these various units.

The communication interface 70 conventionally includes a functional unit dialoging in receive mode Rx and in transmit mode Tx with the serial communication bus 4.

In the example described here, the memory 60 is the information storage medium which stores a computer program PG according to the invention, suitable for implementing, when it is executed by the central processing unit 50, the steps of the communication method according to the invention.

This program PG can use any programming language and can be in the form of source code, object code or intermediate code between source code and object code, such as in a partially compiled form, or in any other desirable form.

The information storage medium 60 can be any entity or device capable of storing the computer program. For example, the medium can comprise a storage means, such as a microelectronic circuit ROM.

Alternatively, the information storage medium can be an integrated circuit in which the program is incorporated, the circuit being suitable for executing, or for being used in the execution of, the method concerned.

It will be noted that, from a hardware point of view, the communication interface (70) of the central computer (2) is combined with the communication interface (not referenced) of the MMI (3). Thus, there is no differentiation between the communication interface (70) of the central computer (2) and the communication interface of the MMI (3). According to an alternative embodiment, the communication between the central computer (2) and the MMI (3) is conducted directly by means of an internal bus, without involving the serial communication bus (4).

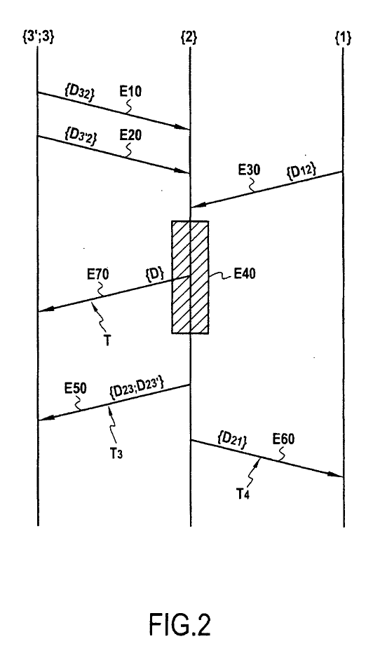

FIG. 2 illustrates the communication method according to the invention, between the MMIs 3, 3′, and the control module 1 of FIG. 1. The MMIs 3, 3′ sequentially send their status data items, respectively denoted D32, D3′2, to the central computer 2, according to the steps E10 and E20 respectively. The central computer 2 receives and reads these data items sequentially. The control module 1 sends data items D12 to the central computer 2, according to the step E30, via the serial communication bus 4 of FIG. 1.

The status data items D32 and D3′2 are data items that represent, for example, activation states or control states of the MMIs 3 and 3′ respectively (for example, the state of activation or confirmation of pressing of a pushbutton, the rotation position of a rotary button). The data items D12 supplied by the control module 1 are data items that represent, for example, the status of the heat algorithm or the status of the vehicle. The data items D12 are generated by the control module 1 from information received from sensors of the air conditioning system and internal states of the algorithms for adjusting the comfort of the air conditioning.

Based on the data items D12, D32, D3′2 received, the central computer 2 processes these data items according to a logical processing step 40 linked to the MMIs. In this step E40, the central computer 2 generates the status data items D23 and D23′. These status data items D23, D23′ describe the states to be displayed on the MMIs 3 and 3′ respectively, such as, for example, a lamp to be switched on or switched off, explicit information to be displayed on a screen.

The central computer 2 also generates the data items D21 describing the status to be taken into account by the heat algorithm (or air conditioning comfort algorithm) within the control module 1.

Thus, the processing of the data items supplied by the MMIs 3, 3′ and by the control module 1 of the air conditioning appliance 10 is centralized on the central computer 2. This centralization of the processing associated with the MMIs 3, 3′ ensures that, if the comfort or performance levels of the air conditioning system are modified, only the control module 1 needs to be modified.

According to a characteristic of the invention, in this step E40, the central computer 2 takes account of any conflicts between the data items D32 and D3′2 according to a priority management algorithm.

Thus, the processing of the data items D12, D32, D3′2 according to the step E40 is performed according to the algorithm for managing priority and processing the logic associated with the MMIs, while taking into account the configuration information contained in the storage means 20. This configuration information relates, for example, to the priority levels to be attached to the various data items D32, D3′2 supplied by the MMIs for their processing according to the step E40 or the distribution of the data items between the MMIs 3, 3′.

According to a step E50, the central computer 2 broadcasts the data items D23, D23′ to the MMIs 3 and 3′, in at least one frame T3. The MMIs 3 and 3′ have means enabling them to recover the data items that are intended for them (respectively D23, D23′). The data items D21 are then transmitted, according to a step E60, by the central computer 2 to the control module 1 in a frame T4.

According to a characteristic of the invention, the central computer 2 can send data items of a general nature D to the MMIs 3, 3′, according to a step E70, in at least one generic frame T, on executing the processing step E40. For example, following the press of a pushbutton on one of the MMIs 3, 3′ to start up the air conditioning appliance 10, data items D for displaying a light indicator can be sent to the MMIs 3, 3′ without having to wait for the end of the processing step E40.

According to another characteristic of the invention, the steps E50 and E60 for sending data items D23, D23′ and D21, respectively to the MMIs 3, 3′ and to the equipment control module 1, can be replaced by a single step according to which these data items are transmitted in a single frame. In other words, the frames T3 and T4 form one and the same frame T5 which is not represented.

According to another characteristic of the invention, the steps E10, E20, E30, E40, E70, E50 and E60 are repeated sequentially.

In the above example, only two control panels 6, 6′ have been considered. For extension to N control panels (N being the total number of control panels linked to the serial communication bus 4), a single control panel will host, in addition to its MMI, the central computer 2 with its configuration data items saved in the storage means 20. The implementation of the N-1 other MMIs and the control module 1 remains unchanged. The data interchanges between the MMIs, the control module 1 and the central computer 2, and the data processing operations on the central computer 2 remain unchanged relative to the implementation described above.

The embodiment described above relates to an air conditioning system. However, other embodiments are, of course, possible, involving equipment items other than an air conditioner, while remaining, naturally, within the framework of the invention. Typical of these other equipment items are, for example, an audio module, a telephone module or a telematics module.

In an embodiment comprising a plurality of equipment control modules and a plurality of MMIs, the central computer 2 distributes the data items generated by the central computer 2 to the plurality of control modules 1 in such a way that each control module receives the data items that are intended for it.

1. System of communication (100) between at least one equipment control module (1) linked to an equipment item (10) and at least one man-machine interface (3, 3′) by means of a serial communication bus (4), characterized in that it further comprises a central computer (2) comprising means suitable for:
receiving at least first status data items (D32, D3′2) transmitted via the man-machine interface (3, 3′) and at least second status data items (D12) transmitted by the equipment control module (1);
processing the first (D32, D3′2) and second (D12) status data items so as to produce at least third (D23, D23′) and fourth (D21) status data items respectively intended for the man-machine interface (3, 3′) and for the equipment control module (1);
broadcasting the third status data items (D23, D23′) to the man-machine interface (3, 3′); and
broadcasting the fourth status data items (D21) to the equipment control module (1).

2. System of communication according to claim 1, characterized in that the central computer (2) is placed in a control panel (6) comprising at least one man-machine interface (3).

3. System of communication according to any one of the preceding claims, characterized in that the central computer (2) comprises a storage means (20) with which to store configuration information.

4. System of communication according to any one of the preceding claims, characterized in that the serial communication bus (4) is an LIN (Local Interconnect Network) type bus.

5. System of communication according to claim 4, characterized in that the man-machine interface (3) is of slave type and in that the central computer (2) is of master type.

6. System of communication according to any one of claims 1 to 3, characterized in that the serial communication bus (4) is a CAN (Controller Area Network) type bus.

7. Method of communication between a central computer (2), at least one equipment control module (1) connected to an equipment item (10), and at least one man-machine interface (3, 3′), characterized in that said central computer (2) performs the following steps:
reception (E10, E20, E30) of at least first status data items (D32, D3′2) transmitted via the man-machine interface (3, 3′) and at least second status data items (D12) transmitted by the equipment control module (1);
processing (E40) of the first status data items (D32, D3′2) and second status data items (D12), so as to generate at least third status data items (D23, D23′) and fourth status data items (D21) respectively intended for the man-machine interface (3, 3′) and the equipment control module (1);
broadcasting (E50) of the third status data items (D23, D23′) to the man-machine interface (3, 3′); and
broadcasting (E60) of the fourth status data items (D21) to the equipment control module (1).

8. Method according to claim 7, characterized in that the third status data items (D23, D23′) and the fourth status data items (D21) are broadcast respectively in at least one frame (T3) and at least one frame (T4).

9. Method according to claim 8, characterized in that the frame (T3) and the frame (T4) form one and the same frame (T5).

10. Method according to any one of claims 7 to 9, characterized in that the central computer (2) broadcasts (E70) generic data items (D) in at least one frame (T) to the man-machine interface (3, 3′) during said data processing step (E40).

11. Method according to any one of claims 7 to 10, characterized in that the central computer (2) processes the data items (D32, D3′2) transmitted via the man-machine interface (3, 3′) according to a priority management algorithm.

12. Method according to any one of claims 7 to 11, characterized in that the steps (E10, E20, E30, E40, E50, E60) of the method are performed periodically.

13. Computer program (PG) comprising code instructions suitable for performing the steps of the communication method according to any one of claims 7 to 12 when the program (PG) is executed on the system of communication according to any one of claims 1 to 6.

14. Information storage medium (60) on which is stored a computer program (PG) comprising code instructions suitable for performing the steps of the communication method according to any one of claims 7 to 12.
